(19) United States
(12) Patent Application Publication
(10) Pub. No.: US 2026/0023216 A1
(43) Pub. Date: Jan. 22, 2026

(54) DESIGN AND ANALYSIS OF PROCESS-VARIATION-TOLERANT SILICON PHOTONIC MICRORING RESONATORS

(71) Applicant: COLORADO STATE UNIVERSITY RESEARCH FOUNDATION, Fort Collins, CO (US)

(72) Inventors: Mahdi Nikdast, Fort Collins, CO (US); Asif Anwar Baig Mirza, Fort Collins, CO (US)

(21) Appl. No.: 19/271,400

(22) Filed: Jul. 16, 2025

Related U.S. Application Data
(60) Provisional application No. 63/672,059, filed on Jul. 16, 2024.

(51) Int. Cl. G02B 6/13; G02B 6/125

(52) U.S. Cl. CPC G02B 6/13; G02B 6/125

(57) ABSTRACT

A process variation tolerant microring resonator is designed based on fabrication process variation (FPV) map data that includes one or more FPV maps that indicate a process variation in a substrate. Waveguide parameter data are estimated from the FPV map, where the waveguide parameter data include estimated waveguide parameters as they are affected by process variations. Microring resonator parameter data are generated from the FPV map data and waveguide parameter data. The microring resonator parameter data includes estimated microring resonator parameters as they are affected by process variations. The waveguide parameter data and microring resonator parameter data can be output as a design for a process variation tolerant microring resonator, which can be further optimized based on user feedback or other constraints.

### CROSS-REFERENCE TO RELATED APPLICATIONS

This application claims the benefit of U.S. Provisional Patent Application Ser. No. 63/672,059, filed on Jul. 16, 2024, and entitled “DESIGN AND ANALYSIS OF PROCESS-VARIATION-TOLERANT SILICON PHOTONIC MICRORING RESONATORS,” which is herein incorporated by reference in its entirety.

### STATEMENT OF FEDERALLY SPONSORED RESEARCH

This invention was made with government support under grant 2006788 awarded by the National Science Foundation. The government has certain rights in the invention.

### BACKGROUND

Microring resonators (MRRs) have emerged as advantageous components in photonic integrated circuits, offering compact footprints and versatile functionalities for applications in optical communication, sensing, and signal processing. These devices rely on precise geometric configurations to achieve desired optical characteristics. However, fabrication process variations (FPVs) inherent in semiconductor manufacturing can lead to deviations from intended designs, potentially impacting device performance and reliability.

As photonic integrated circuits become more complex and densely integrated, the effects of FPVs on MRR performance become increasingly pronounced. Variations in waveguide dimensions, material properties, and structural parameters can result in shifts in resonant wavelengths, changes in coupling efficiencies, and alterations in quality factors. These variations pose challenges for achieving consistent and predictable MRR behavior across large-scale photonic integrated circuits. Consequently, there is growing interest in developing design methodologies and tools that can account for and mitigate the impacts of FPVs on MRR performance, enabling more robust and reliable MRR-based photonic integrated circuits.

### SUMMARY OF THE DISCLOSURE

The present disclosure addresses the aforementioned drawbacks by providing a method for designing a microring resonator. The method includes accessing fabrication process variation (FPV) map data with a computer system. The FPV map data includes at least one FPV map indicating a process variation in a substrate. Waveguide parameter data are generated from the FPV map data. The waveguide parameter data includes estimated waveguide parameters as affected by process variations associated with the FPV map data. Microring resonator parameter data are also generated from the FPV map data and the waveguide parameter data. The microring resonator parameter data include estimated microring resonator parameters as affected by process variations associated with the FPV map data. The waveguide parameter data and microring resonator parameter data are output with the computer system as a design for fabricating a process variation tolerant microring resonator.

### BRIEF DESCRIPTION OF THE DRAWINGS

FIGS. 1A-1F illustrate an example workflow (FIG. 1F) of a comprehensive approach for designing fabrication-process variation (FPV)-resilient microring resonators (MRRs). The workflow encompasses: (FIG. 1A) generating realistic, virtual FPV maps across a wafer and individual dies, (FIG. 1B) analyzing the impact of FPVs on strip and ridge waveguides using computationally efficient and accurate models; (FIG. 1C) exploring the impact of MRR layout on its robustness under variations (e.g., adiabatic MRRs), considering coupling effects and variations on ring parameters; (FIG. 1D) calculating cross-over coupling coefficients for various waveguide dimensions; and (FIG. 1E) exploring and optimizing MRR designs to meet user-specified performance requirements in terms of, for example, extinction ratio, quality factor, bandwidth, etc. Top graphs in FIG. 1E show variations in free spectral range (FSR) and extinction ratio with ring radius, while bottom graphs demonstrate optimized values for specific design requirements.

FIG. 2 shows an example of virtual process variation maps showing changes in waveguide width, thickness, and radius at both wafer and die level.

FIG. 3 illustrates an example workflow showcasing: (a) the effect of width and thickness variations on n_{eff} and n_{g} for strip/ridge waveguides, and (b) the impact of FPVs on MRR performance metrics (resonant wavelength shift (Δλᵣ), FSR, transmission spectrum).

FIG. 4 is a flowchart of an example method for designing and manufacturing a process variation tolerant microring resonator.

FIG. 5 illustrates design exploration and optimization for maximum tolerance towards FPV in adiabatic MRRs, in which selection of optimal adiabatic MRR design parameters (see figure inset) are aimed to reduce impact of Δλᵣ under FPVs.

FIG. 6 illustrates through-port and drop-port response in (a) conventional and (b) adiabatic MRRs. Black-dotted lines show the ideal (nominal) resonant wavelengths.

FIG. 7 is a block diagram of an example system for designing a process variation tolerant microring resonator.

FIG. 8 is a block diagram of example components that can implement the system of FIG. 7.

FIG. 9 shows an example of a photonic integrated circuit (PIC) that includes adiabatic MRRs designed using the methods described in the present disclosure. The PIC is designed to include microring modulators (MRM) with microheaters for large-range calibration and PN junctions for optical modulation.

FIG. 10 shows a closeup of the PIC shown in FIG. 9 and a schematic layout of MRM devices 1-6.

FIGS. 11A-11F show MRM sweep data (FIGS. 11A, 11C, 11E) and heater performance data (FIGS. 11B, 11D, 11F) for MRM devices 4-6 from FIG. 10. In FIGS. 11A, 11C, and 11E, P is the heater power. The results show a shift in microring response based on different power applied to the heater, and hence different temperature.

### DETAILED DESCRIPTION

Described here are systems and methods for designing and fabricating microring resonators that are tolerant to fabrication process variations (FPVs). In some implementations, adiabatic microring resonators (MRRs) can be designed and fabricated. Advantageously, adiabatic MRRs can enable seamless signal transfer within the resonator without incurring significant losses, and also allow for an additional layer of tolerance towards fabrication discrepancies.

The disclosed systems and methods provide a framework for designing and fabricating process variation tolerant MRRs. Advantageously, the disclosed framework is adaptable to user specifications, such that MRRs can be customized to meet the specific requirements of various test cases. For instance, if the primary objective is to maximize tolerance towards FPVs, the MRR design can be modified to give less priority to silicon area consumption. Conversely, if a user desires a smaller ring radius, tolerance towards fabrication variability can be slightly reduced, resulting in an adiabatic ring that maintains signal integrity and enables seamless transfer of the optical signal. By harnessing this flexibility, not only is MRR performance optimized, but ring configurations that are finely tuned to the unique demands of each user scenario can be designed. This adaptive capability enables MRR designs where customization and efficiency converge to drive advancements in silicon photonics.

The disclosed framework provides a process variation tool tailored to investigate how different photonic devices behave under varying manufacturing conditions. The framework can be used to reveal diverse scenarios influencing device design and provides insights for performance improvement. Notably, it facilitates this analysis at a low execution cost, using computationally efficient and accurate models to offer advantageous insights into device behavior. The disclosed framework can therefore contribute to the evolution of silicon photonics in addition to addressing an notable aspect of device design by offering a practical and cost-effective approach for optimizing device performance in real-world conditions.

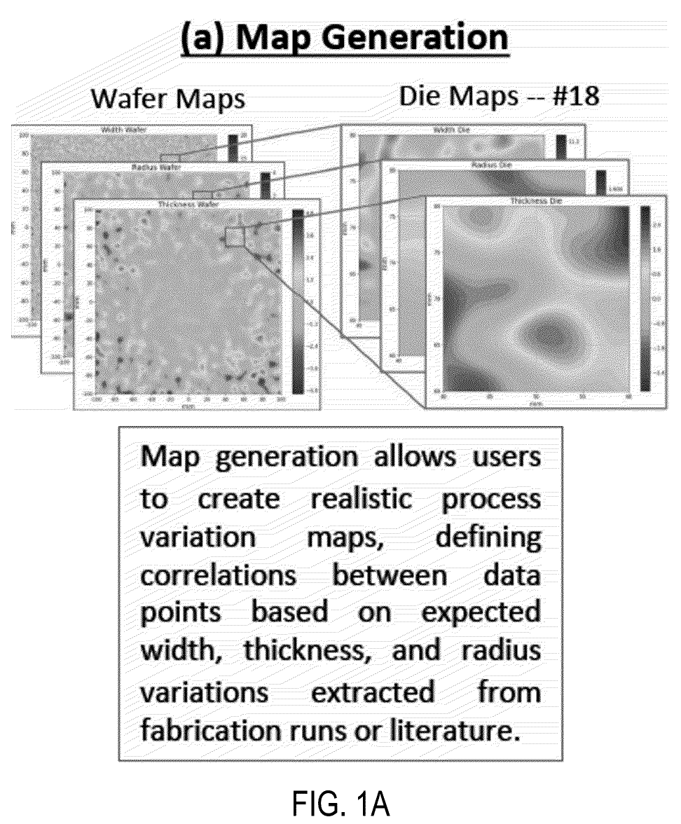

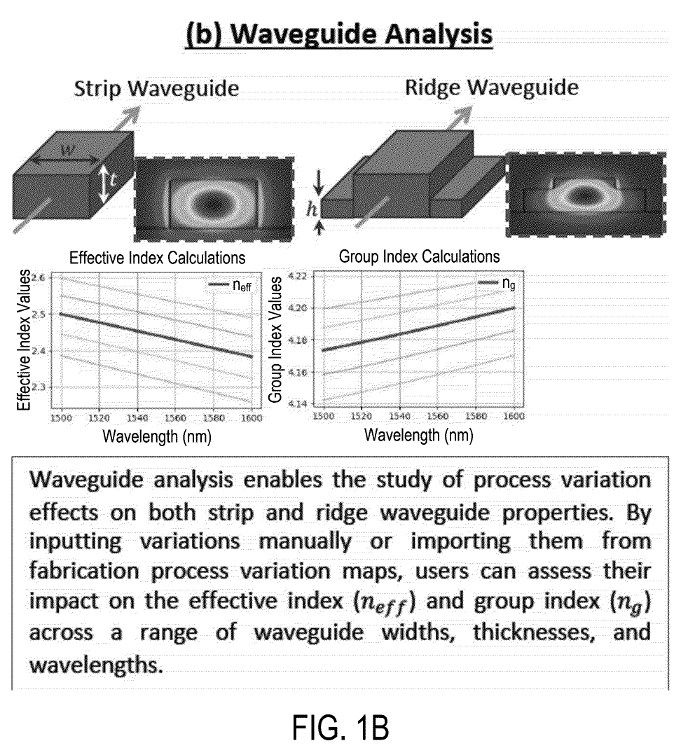

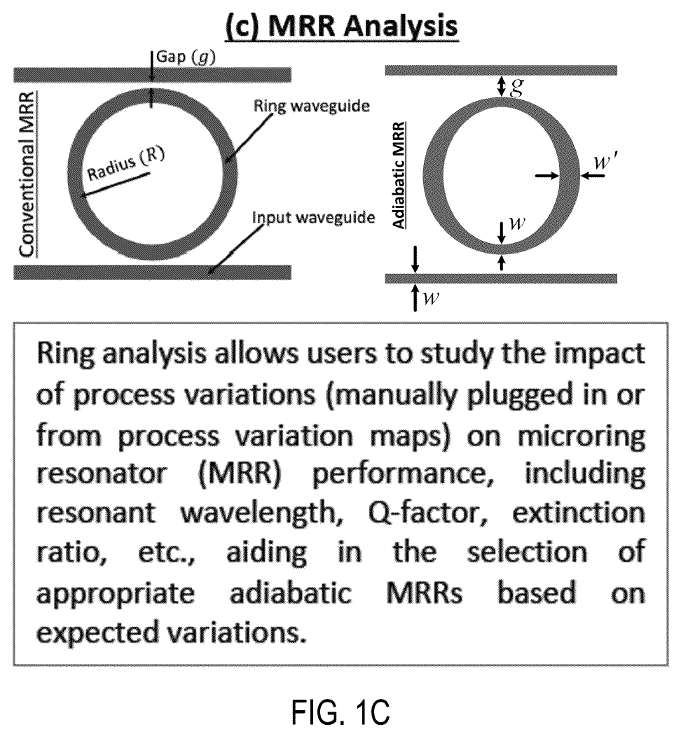

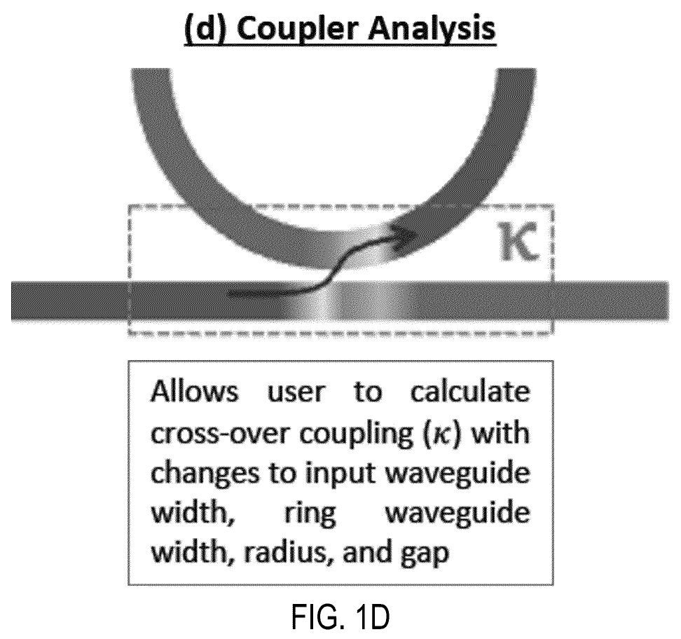

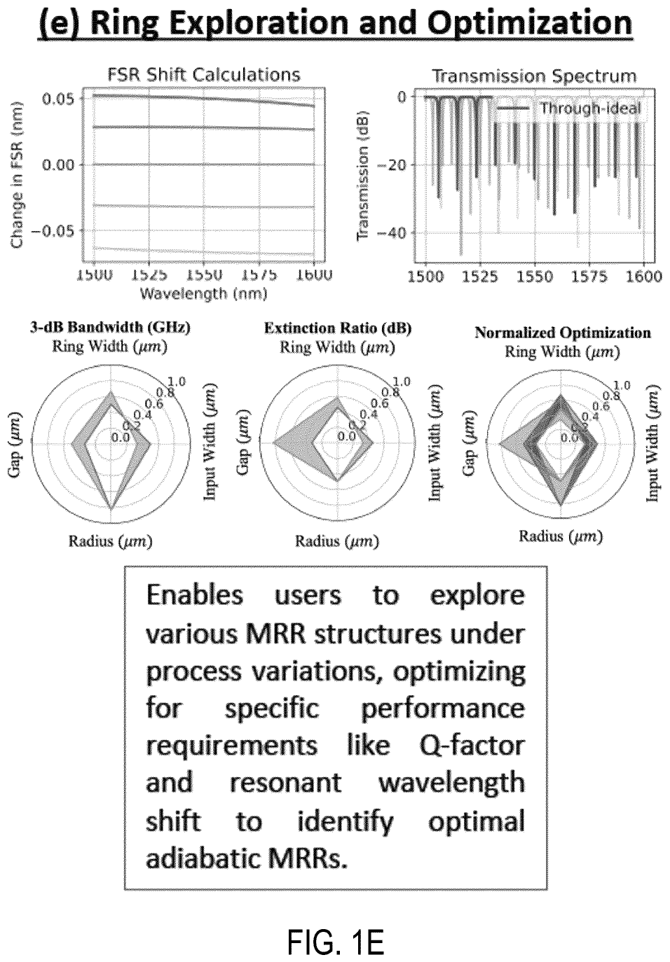

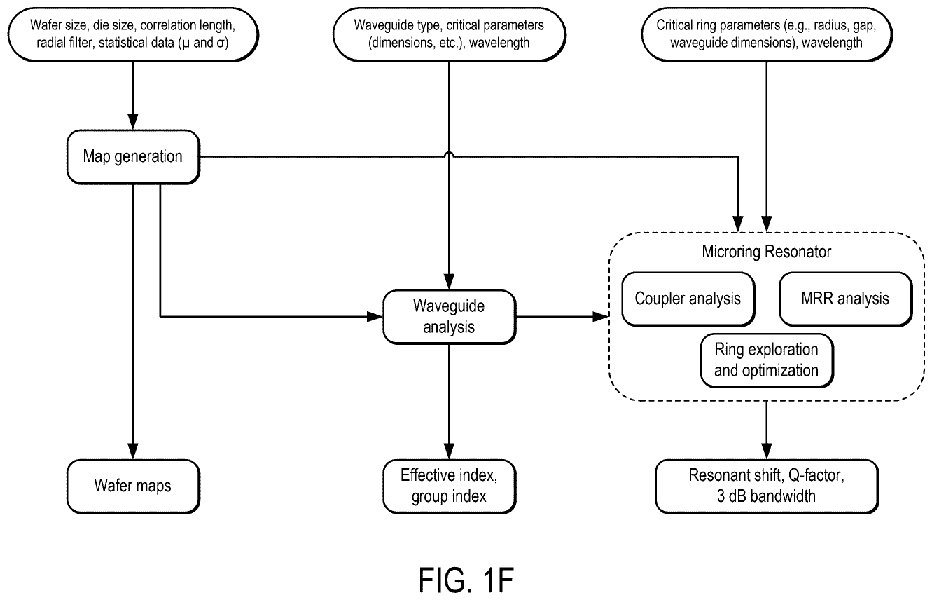

It is an aspect of the present disclosure to provide a framework for MRR design, which encompasses a thorough exploration of how variations impact the overall design considerations for an. FIGS. 1A-1F illustrate a visual aid of analyses taken into account throughout the design phase of an adiabatic MRR. By meticulously examining the intricate interplay between various factors, including FPVs, material properties, and structural dimensions, the disclosed framework aims to provide a comprehensive understanding of shaping MRR performance. Through systematic analysis and iterative refinement, robust and resilient designs capable of withstanding the challenges posed by inherent variations can be achieved using the disclosed framework, while optimizing performance across a range of operational scenarios.

When designing an adiabatic MRR, the expected variations inherent to the device should be taken into account. Such an analysis is facilitated in the disclosed framework by utilizing process variation maps. Inputs to these process variation maps can include statistical details such as wafer size, correlation length, die size, and expected mean and standard deviation across the wafer. FPVs represent a primary source of signal degradation in silicon photonic devices. Even small FPVs (e.g., as small as 2 nm in an MRR) can induce a significant shift (e.g., 1.2 nm shift) in the resonant wavelength. In systems incorporating numerous MRR devices, these variations can cumulatively escalate the total power consumption. Consequently, comprehending and accommodating photonic device variations can provide significant advantages, including reduced power consumption and improved device reliability. These advantages can be achieved using the disclosed framework, which provides a comprehensive grasp of the patterns and trends in process variations across wafers as well as within individual dies.

Based on a comprehensive understanding of the expected variations inherent to a device, the overall changes in critical parameters can be analyzed. These parameters, including waveguide width, SOI thickness, and slab thickness, significantly influence metrics such as effective index (n_{eff}) and group index (n_{g}), thereby impacting performance parameters. To fully comprehend the behavior of a MRR under variations, it is essential to maintain control over all critical parameters. This includes regulating the width of both the input and ring waveguides, silicon-on-insulator (SOI) thickness, gap dimensions, and the radius of the ring. Such control enables changes in parameters such as resonant wavelength, extinction ratio (ER), and free spectral range (FSR) to be discerned. With a comprehensive understanding of expected variations and control over critical parameters, a search for optimization of performance parameters can be conducted. This involves, for example, iteratively adjusting ring parameters to achieve an optimized design that is adiabatically constructed, tolerant to FPVs, and tailored to specific user requirements.

In order to design for tolerance towards FPVs, FPVs should be accounted for not only across a single die, but also across the entire wafer.

FPV wafer maps can be generated as follows. Initially, an uncorrelated random distribution map with specified mean (μ) and standard deviation (σ) is created. Subsequently, a convolution can be applied to this map (e.g., using a Gaussian filter with a designated correlation length (l)), thereby obtaining correlated FPV wafer maps. In some implementations, the fidelity of these correlated FPV maps can be enhanced by integrating radial-variation effects. This entails acknowledging the non-uniformity in variations, which escalates as one moves from the wafer center towards its edges. Consequently, the center of the FPV map exhibits the least variations.

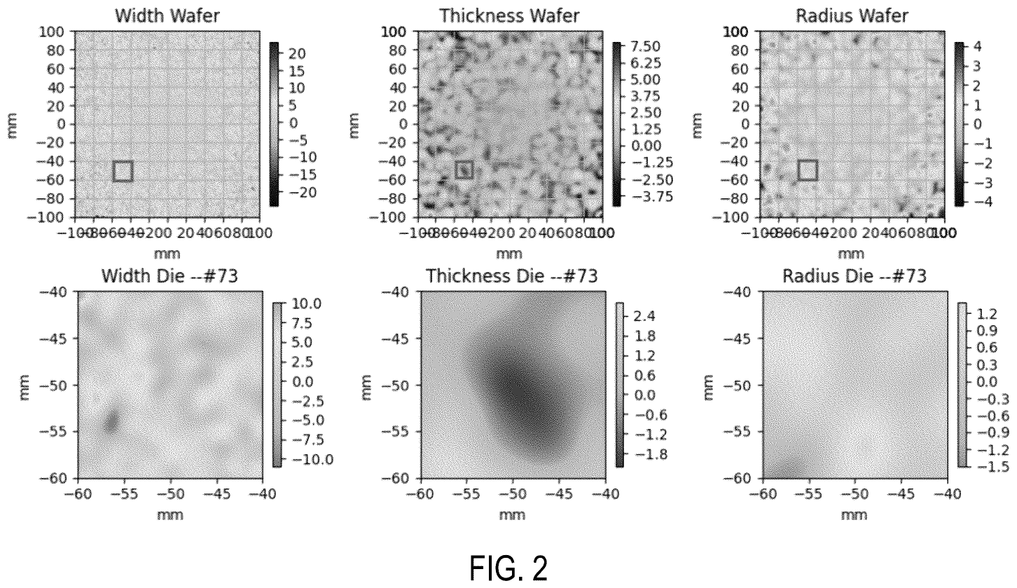

To accurately capture radial-variation effects, waveguide width and SOI thickness variations (referred to as σ_{w} and σₜ, respectively) can be characterized. For example, a thorough characterization of waveguide width and SOI thickness variations was conducted at the center of several 200 mm wafers. This characterization process can be replicated at multiple points across the wafer, spanning from the center to the periphery. Subsequently, the standard deviations obtained are averaged over the points within the same distance from the wafer center, facilitating a comprehensive understanding of radial variations, as depicted in FIG. 1A and in FIG. 2. FIG. 1A shows a 200 mm wafer map and a random die #18 and FIG. 2 shows a 200 mm wafer map and a random die #73, which were chosen and expanded showing variations in waveguide width, thickness, and radius.

The disclosed framework not only enables the generation of various variation maps, but also offers control over the inclusion of radial effects within these maps. This empowers users with the capability to tailor process variation maps to suit specific test cases by using accurate mathematical models. This flexibility facilitates customized design solutions tailored to individual requirements.

In addition to exploring into ring characteristics and parameters, the disclosed framework examines how waveguide parameters are influenced by FPVs. For example, the framework accounts for the impact of FPVs on waveguide parameters and, consequently, their effects on performance metrics such as effective index (n_{eff}) and group index (n_{g}). Studies of propagation constant, effective index, and group index of the fundamental transverse electric (TE) mode in both strip and slab waveguides under FPVs can be used to guide parameters used in the disclosed framework. For example, an approximate analysis for calculating the propagation modes of waveguides based on Marcatili's approach can be used. It is worth noting that the nₑf in a waveguide is contingent upon both the optical wavelength and critical dimensions of the waveguide, including parameters such as width (w), thickness (t), and slab thickness (h) in the case of a slab waveguide:

$${n}_{eff} ( λ , w , t , h ) = ( \frac{λ}{2 π} ) β ( λ , w , t , h ) ; \qquad ( 1 )$$

where β is the propagation constant and λ is the optical wavelength. Leveraging Eqn. (1), the group index (n_{g}) in a waveguide can be defined as:

$${n}_{g} ( λ , w , t , h ) = {n}_{eff} ( λ , w , t , h ) - λ \frac{\partial {n}_{eff} ( λ , w , t , h )}{\partial λ} . \qquad ( 2 )$$

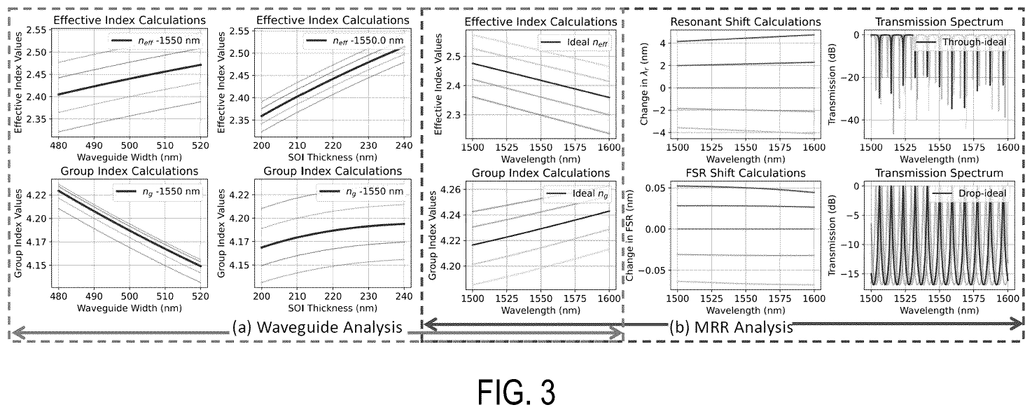

Primary analyses aimed at calculating variations in n_{eff} and n_{g} can be conducted. Leveraging changes in waveguide dimensions, an understanding of how alterations in parameters such as n_{eff} and n_{g} occur can be implemented in the disclosed framework. FIG. 3 visually depicts the changes in waveguide parameters resulting from the effects of FPVs. The trends in variations of n_{eff} and n_{g} corresponding to changes in input wavelength, waveguide width, and SOI thickness are presented in FIG. 3. The disclosed framework enables a user to enter a wider variety of ranges based on their requirements to better understand the trends and changes in waveguide parameters.

In the analysis of MRRs, several critical characteristics, including the resonant wavelength (λ_{R}), cross-over coupling (κ), free spectral range (FSR), and the transmission spectrum of the MRR, can be analyzed to examine how they are influenced by FPVs. Robust mathematical models can be utilized to interpret the trends in changes observed in these parameters due to FPVs.

The resonant wavelength (λ_{R}) defines the optical wavelength at which the MRR is in resonance. This parameter is determined by various factors within the MRR design space, encompassing attributes such as the radius, gap between the input and ring waveguides, and waveguide dimensions, including width and SOI thickness. The resonant wavelength (λ_{R}) can be calculated using the effective index obtained from Eqn. (1) as:

$${λ}_{R} ( w , t , h , R ) = ( \frac{2 π R}{m} ) {n}_{eff} ( {λ}_{R} , w , t , h ) ; \qquad ( 3 )$$

where R is the radius of the MRR and m is the integer that denotes the order of the resonant mode. Even minor deviations in waveguide dimensions, such as waveguide width (w), SOI thickness (t), and slab thickness (h) can lead to fluctuations in the resonant wavelength. These deviations are commonly referred to as resonant wavelength shifts (Δλ_{R}), which can be expressed as:

$$Δ {λ}_{R} ( w , t , h , R ) = ( \frac{2 π R}{m} ) Δ {n}_{eff} ( {λ}_{R} , w , t , h ) . \qquad ( 4 )$$

Based on these equations, the changes in resonant wavelength resulting from variations in waveguide dimensions can be accurately captured. FPVs also exert an influence on the overall performance of MRRs, introducing additional losses as optical signals traverse or are coupled into and out of the MRR. These power losses can significantly degrade the efficiency of circuits incorporating MRRs, underscoring the importance of monitoring the cross-over coupling coefficient (κ), which quantifies the coupling between the input/drop waveguide and the ring. To ensure accuracy, cross-over coupling coefficient (κ) is typically approximated using precise numerical methods, such as Finite-Difference Time-Domain (FDTD) simulations, across a wide range of radius values. To systematically study the impact of FPVs on the cross-over coupling coefficient (κ) in MRRs, the following compact yet comprehensive model can be used as part of the disclosed framework:

$$κ ( {λ}_{R} , {w}^{′} , {t}^{′} , {h}^{′} , {R}^{′} ) = f ( {n}_{eff} ( {λ}_{R} , {w}^{′} , {t}^{′} , {h}^{′} ) , {R}^{′} , {g}^{- 1} ) ; \qquad ( 5 )$$

where λ_{R}, w′, t′, h′, R′ are changes in resonant wavelength, width, SOI thickness, and slab thickness in a ridge waveguide respectively. Note that changes in cross-over coupling are inversely proportional to changes in gap (g) and directly proportional to ring radius (R).

The disclosed framework incorporates an analysis beyond critical ring parameters to explore additional characteristics, including the Q-factor, extinction ratio (ER), and 3 dB bandwidth, which undergo changes in response to variations in ring dimensions. The Q-factor measures the sharpness of resonance relative to its central frequency within MRRs. It plays a significant role in influencing various aspects of MRR performance, including optical channel spacing, crosstalk, bandwidth, and other related characteristics. By quantifying the Q-factor, valuable insights into the spectral selectivity and efficiency of MRRs can be gained, enabling the optimization of their performance for specific applications. Q-factor can be modeled as:

$$Q ( {λ}_{R} , w , t ) = \frac{{π}^{2} R \sqrt{1 - {κ}^{2}} {n}_{g}}{{λ}_{R} {κ}^{2}} . \qquad ( 6 )$$

The ER in a MRR can be expressed by:

$$ER = 10 {{log}_{10} [ \frac{( \sqrt{1 - {κ}^{2}} + a \sqrt{1 - {κ}^{2}} ) ( 1 - a ( 1 - {κ}^{2} ) )}{( \sqrt{1 - {κ}^{2}} - a \sqrt{1 - {κ}^{2}} ) ( 1 + a ( 1 - {κ}^{2} ) )} ]}^{2} ; \qquad ( 7 )$$

where a is the field round-trip loss coefficient of the ring (no loss: a=1) and κ is the cross-over coupling coefficient.

Leveraging these comprehensive models enables the efficient determination of various parameters of a MRR, thereby enabling the calculation of an optimized MRR design that aligns specifically to a user requirement. FIG. 3(b) captures the changes in ring parameters due to FPVs and corresponding deviations in resonant wavelength, FSR, and ER. These variations have been taken directly from generated FPV maps. By accurately capturing the intricate interplay between FPVs and MRR characteristics, MRR designs can be tailored to meet specific performance criteria and application needs. This optimization process not only enhances the functionality and reliability of MRR-based photonic devices, but also ensures that the devices deliver optimal performance across a diverse range of operational scenarios.

According to some implementations, a method for designing and fabricating a process variation tolerant MRR may include exploring different MRR design parameters and layout configurations based on a compact model that performs a design-space exploration of the MRR under fabrication process variations. As described above, this compact model may be based, at least in part, on the virtual FPV maps and/or waveguide parameters or MRR parameters estimated as being affected by process variations. An MRR layout may be generated based on the design-space exploration, where the MRR layout is tolerant to the fabrication process variations. The process variation tolerant MRR may then be fabricated according to the MRR layout.

Using the methods described in the present disclosure, adiabatic MRRs can be designed and fabricated. These adiabatic MRRs enable seamless signal transfer within the resonator without incurring significant losses. Additionally, the adiabatic MRR designs provide an additional layer of tolerance towards fabrication discrepancies. Advantageously, the methods described in the present disclosure enable adaptability of MRR design specifications to user specifications. The disclosed framework allows for MRR designs to be customized to meet the specific requirements of various test cases. For instance, if the primary objective is to maximize tolerance towards FPVs, the ring design can be modified to give less priority to silicon area consumption. As another example, if a user desires a smaller ring radius, tolerance towards fabrication variability can be slightly reduced, resulting in an adiabatic ring that maintains signal integrity and enables seamless transfer of the optical signal. By harnessing this flexibility, MRR designs can be generated not only with optimized performance, but also while proposing ring configurations that are finely tuned to the unique demands of each user scenario. This adaptive capability enables an MRR design framework where customization and efficiency converge to drive advancements in silicon photonics.

As described above, it is an aspect of the present disclosure to provide a comprehensive approach to the design and analysis of MRRs, including adiabatic MRRs. The disclosed framework explicitly takes into account the impact of process variations during the MRR design phase. This framework allows users to make informed choices when selecting MRRs customized to their specific design requirements.

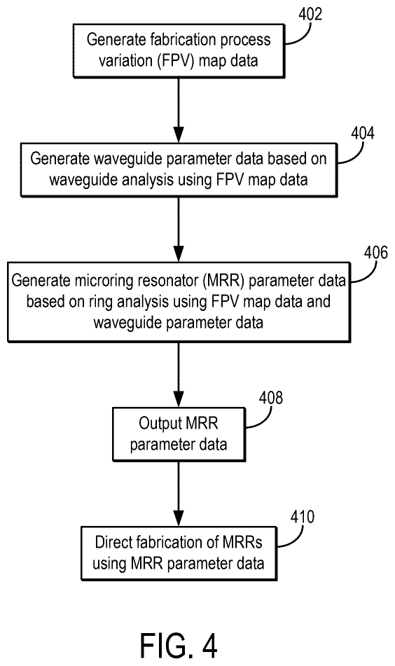

Referring now to FIG. 4, a flowchart is illustrated as setting forth the steps of an example method for designing and manufacturing an MRR in accordance with a process variation informed design framework.

The method includes generating FPV map data with a computer system, as indicated at step 402. The FPV map data may be generated with the computer system by modeling fabrication process variations as described herein. Additionally or alternatively, generating the FPV map data may include retrieving previously generated FPV map data from a memory or other suitable data storage device or medium.

In general, the FPV map data include one or more FPV maps. As an example, an FPV map includes a detailed wafer map that accounts for variations in waveguide width, thickness, and radius. In addition, the FPV maps may mimic or otherwise indicate statistical distributions and variations in the fabrication process (e.g., correlated variations, radial effects). In some embodiments, the FPV map data may include separate width variation maps, thickness variation maps, and radius variation maps. When generating an FPV map, as described above, inputs used to generate these maps may be received by the computer system, including wafer size, die size, correlation length, radial filter, and/or statistical data (e.g., mean and standard deviation across the wafer).

Subsequent to this variation analysis, waveguide parameter data are generated with the computer system, as indicated at step 404. For example, a waveguide analysis that incorporates the effects of FPVs on its performance is conducted using the FPV map data. In some implementations, analyzing the effects of process variation on a singular waveguide can be conducted by studying the changes in effective index (n_{eff}) and group index (n_{g}) due to changes in input wavelength and waveguide dimensions, such as waveguide width and SOI thickness. Techniques for implementing such a waveguide analysis are described above. When generating the waveguide parameter data, inputs used to generate these data may be received by the computer system, including waveguide type, critical parameters (e.g., dimensions), and wavelength. The output waveguide parameter data can include effective index (n_{eff}) and/or group index (n_{g}) values.

MRR parameter data are then generated with the computer system using an MRR analysis of the FPV map data and waveguide parameter data, as indicated at step 406. Based on the understanding of the process variations provided by the FPV map data, the design of MRRs can be conducted by systematically evaluating various parameters, such as changes in resonant wavelength, free spectral range (FSR), and transmission spectrum. To afford users the flexibility to set specific limitations according to their design needs, a focused optimization of critical parameters in an MRR can be conducted. Examples of such critical parameters can include the Q-factor, extinction ratio (ER), 3 dB bandwidth, and total resonant wavelength shift.

In one aspect, the MRR analysis can include a coupler analysis stage, a ring analysis stage, and/or a ring exploration and optimization stage. In the coupler analysis stage, the cross-over coupling in an MRR is analyzed for given width, radius and gap parameters, as described above. In the ring analysis stage, a ring design is selected to start exploration. Changes in effective index and other ring parameters are then analyzed. The ring design can be studied for improving the tolerance towards process variations. An appropriate ring design for improved performance towards process variations is then determined. As described above, an optimal ring design can be chosen based on restrictions placed by the user, such as restrictions placed based on the application of the MRR. Examples of MRR parameter data than can be output include resonant shift, Q-factor, and/or 3 dB bandwidth.

As a non-limiting example, by increasing the waveguide width, the rate of changes in the effective index (n_{eff}) with respect to the variations in the waveguide width (w) decreases, while such a rate remains almost the same under waveguide thickness (t) variations. This implies that by increasing the waveguide width in an MRR, one should expect higher tolerance under FPVs in the device. However, uniformly increasing the waveguide width in an MRR will result in undesired optical mode distortion and excitation. This suggests that using an adiabatic MRR design using curved, tapered waveguides within the ring by gradually increasing the ring waveguide's width from the input (i.e., w) to the center (i.e., w′) to avoid optical mode distortions and excitation of higher order modes in the MRR.

The resonant wavelength

$$( {λ}_{R}^{a} )$$

in an adiabatic MRR can be modeled based on its effective index

$$( {n}_{eff}^{a} )$$

as:

$${λ}_{R}^{a} = ( \frac{2 π R}{m} ) {n}_{eff}^{a}$$

where R is the radius of the MRR and m is an integer that denotes the order of the resonance. Also,

$${n}_{eff}^{a}$$

can be approximated by taking the average of effective indices when considering w and w′ waveguide widths: i.e.,

$${n}_{eff}^{a} = \frac{1}{2} ( {n}_{eff} ( w ) + {n}_{eff} ( {w}^{′} ) ) .$$

### Accordingly,

$${λ}_{R}^{a}$$

in an adiabatic MRR is impacted by the critical dimensions of the MRR and its radius. Slight variations (e.g., due to FPVs) will deviate

$${λ}_{R}^{a} ,$$

which may be referred to as a resonance-wavelength shift,

$$δ {λ}_{R}^{a} .$$

In order to model

$$δ {λ}_{R}^{a}$$

in an adiabatic MRR, a compact model can be defined based on:

$${δλ}_{R}^{a} = ( \frac{{λ}_{R}^{a} \vert {n}_{eff}^{a} - {n}_{eff}^{a †} \vert}{{n}_{g}^{a}} ) + ( \frac{{λ}_{R}^{a} {R}^{†}}{R} ) \frac{{n}_{eff}^{a}}{{n}_{g}^{a}}$$

where

$${n}_{eff}^{a †}$$

and R^{†} are the effective index and radius of the MRR that have changed due to FPVs, and

$${n}_{g}^{a}$$

is the ideal group index in the MRR, which can be calculated using

$${n}_{eff}^{a}$$

Accordingly, compared to conventional MRRs, adiabatic MRRs can benefit from reduced

$$δ {λ}_{R}^{a}$$

by carefully designing w and w′ using the methods described in the present disclosure.

The MRR parameter data can then be output with the computer system, as indicated at step 408. Outputting the MRR parameter data may include displaying the MRR parameter data to a user, such as via a graphical user interface (GUI) of the computer system, or the like. Additionally or alternatively, outputting the MRR parameter data can include storing the MRR parameter data for later use or processing.

In some implementations, outputting the MRR parameter data with the computer system can include sending the MRR parameter data to an appropriate fabrication system to direct fabrication of MRRs according to the MRR parameter data. For example, as indicated at step 410, the fabrication of MRRs can be directed using the MRR parameter data. In this way, one or more MRRs can be fabricated according to the design parameters contained in the MRR parameter data. In some instances, additional data (e.g., waveguide parameter data, FPV map data) can also be used to guide the fabrication of MRRs. Based on this process, the resulting MRRs will be tolerant to process variations, as described above.

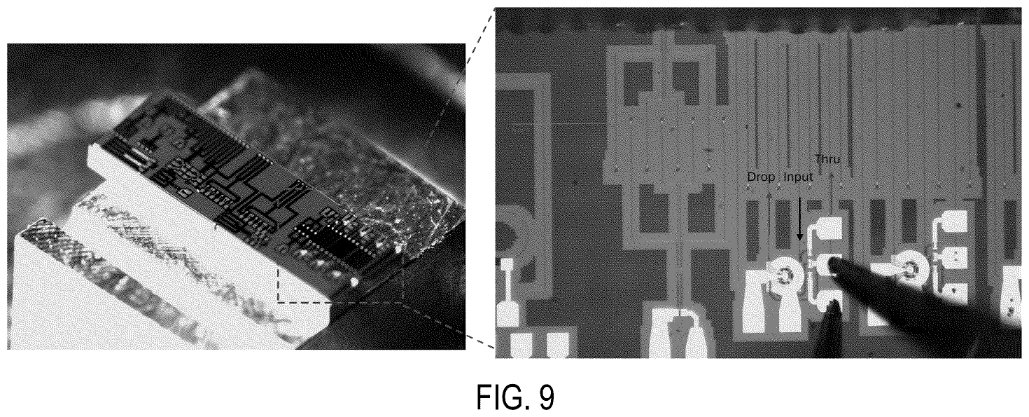

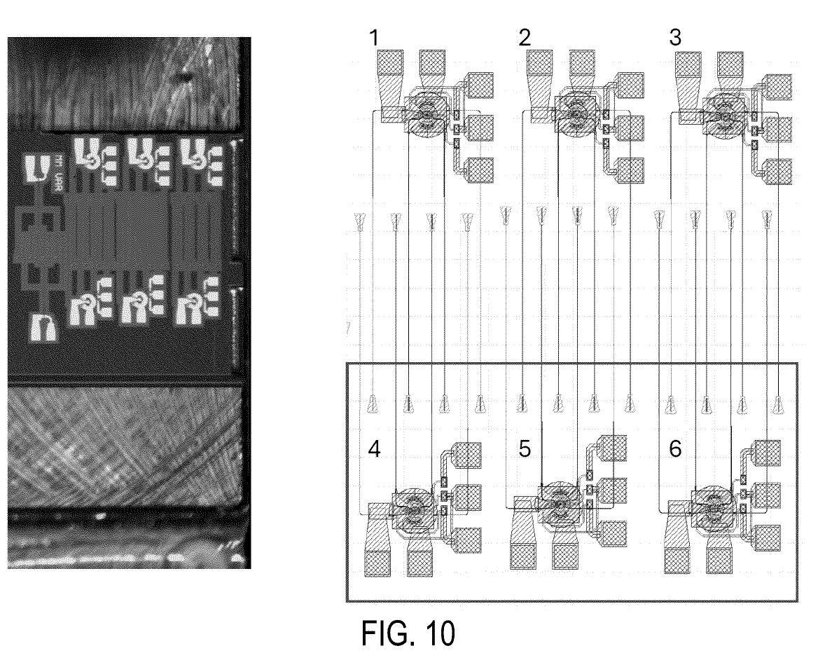

As one non-limiting example, the MRR parameter data can be used to fabricate one or more adiabatic MRRs. The adiabatic MRRs can be fabricated as part of a photonic integrated circuit (PIC). For instance, as shown in FIGS. 9 and 10, the MRR parameter data may be used to fabricate adiabatic MRRs for use in microring modulators (MRMs) on a PIC. Additionally or alternatively, the MRRs may be fabricated for use in other photonic circuits, photonic devices, sensors, optical filters, switches, modulators, or the like.

Adiabatic MRRs present an advantageous alternative to traditional MRRs across various applications. In scenarios where high-speed data transfer between two optical chips is important, the adoption of adiabatic MRRs holds the potential for substantial reductions in power consumption. Transceivers, pivotal for facilitating communication between data centers, typically incorporate MRRs in their design. By substituting traditional MRRs with adiabatic MRRs, such as those designed using the methods described in the present disclosure, the efficiency of transceiver designs can be significantly enhanced. Moreover, a considerable portion of optical communication utilizes MRRs. The transition to adiabatic MRRs can enable enhanced signal integrity, thereby facilitating power reduction in data-intensive applications such as artificial intelligence and machine learning.

In an example study, the versatility of analysis achievable through the disclosed framework for designing FPV tolerant MRRs was investigated. Test cases were explored to illustrate the effectiveness of the disclosed framework. Optimization was performed to design MRRs for maximum tolerance towards FPVs, ensuring robust performance under varying manufacturing conditions. The example study demonstrated the adaptability and versatility of the disclosed MRR design framework in catering to diverse user requirements and performance objectives.

The proposed process variation analysis tool (ProVAT) streamlines the entire analysis process, including the generation of microring layouts. Utilizing ProVAT, precise estimates for both the wafer and the die on which the microring resonator will be placed for analysis were initially generated.

In the analysis of the impact of FPVs on MRR performance, changes in the effective index and group index were the primary focus of observation. The influence of effective index and group index on parameters such as resonant wavelength, free spectral range (FSR), and the transmission spectrum itself were assessed. Through the example study, a direct correlation between the total variation observed in the die and the expected changes in ring parameters was established.

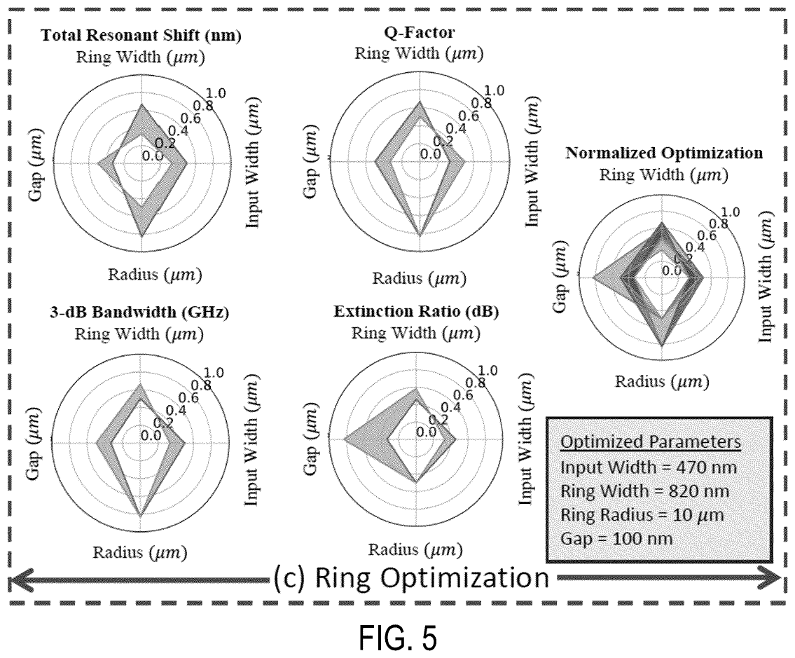

FIG. 5 visually captures the exploration and optimization aspects facilitated by the ProVaT framework. The normalized radial charts depicted in FIG. 5 illustrate variations in input waveguide width, ring waveguide width, radius, and ring gap. These charts provide insight into optimized solutions for fabricating process variation tolerant MRRs. Additionally, these charts enable simultaneous observation of critical parameters such as the Q-factor, extinction ratio (ER), and 3 dB bandwidth. The overlap region among all critical parameters signifies an optimal design configuration for the microring resonator, ensuring robust performance while maintaining tolerance to FPVs. Additionally, these optimized design parameters can be seamlessly translated into K-layouts by using a layout feature to further facilitate their fabrication and integration into photonic circuits.

Overall, this study showcased the flexibility and utility of the disclosed framework in designing MRRs with high Q-factor and moderate tolerance towards FPVs, thereby advancing the development of advanced photonic devices for a wide range of applications.

In a non-limiting example, by utilizing the disclosed MRR design-space exploration framework, two TE-polarized MRR test structures (one conventional MRR and one adiabatic MRR) were designed based on add-drop structures. The design parameters of the adiabatic MRRs were based on an optimization analysis performed using the methods described in the present disclosure. The MRR design was optimized for tolerance towards FPVs and to improve the reliability of the MRR. The example conventional and adiabatic MRRs were designed with the same overall size so that they experience similar FPVs while keeping their nominal resonant wavelengths as close as possible (i.e., 1550 nm in conventional and 1546 nm in adiabatic). Note that the resonant wavelength difference between conventional and adiabatic MRRs did not hinder the analysis. Moreover, 268 identical copies of MRR1 (the conventional MRR) and 289 identical copies of MRR2 (the process variation tolerant adiabatic MRR) were strategically placed across a 10×10 mm chip fabricated using a standard E-Beam multi-project wafer (MPW) process, where each pair of conventional and adiabatic MRRs were placed as close as possible to ensure that they experience similar FPVs.

In-house testing was performed where the temperature of the chip stage was maintained at 300 K to eliminate the impact of thermal variations during the measurements. The input power was set to 7.5 dBm, for which a total loss of 25.2 dB in the output was experiences. The loss due to grating couplers was 17.6 dB (i.e., 8.8 dB each), and the loss for each device was estimated to be ≈1 dB. Accordingly, the total unaccounted losses due to the test and alignment was ≈6.6 dB.

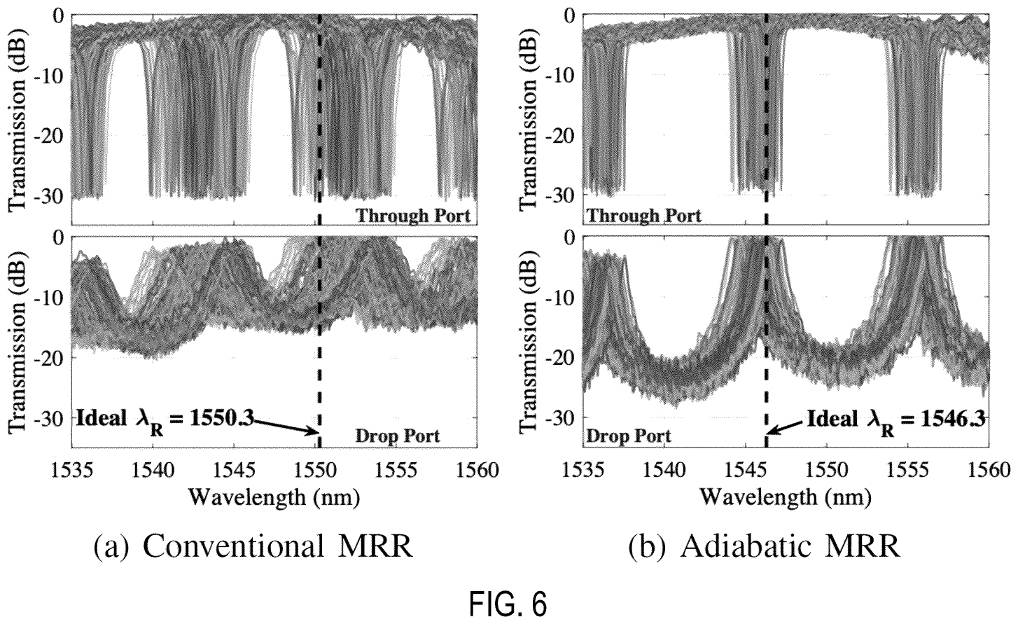

Considering the through-port and drop-port responses in FIG. 6, the responses of the adiabatic MRR aligned closer to the ideal response at 1546.3 nm by up to 70% on average, compared to the conventional MRRs whose ideal response is at 1550.3 nm. For a more complete experimental comparison between MRR1 and MRR2, Table 1 shows the measurement results across multiple performance metrics. By fabricating the optimized, the disclosed framework to design robust MRRs was validated.

TABLE 1
Characterized device performance (Avg.: Average, SD: Standard
Deviation, λ_{R}: Resonant Wavelength, ER: Extinction Ratio).

| | MRR1 (Conventional) | | MRR2 (Adiabatic) | |
|---|---|---|---|---|
| | Through | Drop | Through | Drop |
| Avg. λ_{R} | 1552.8 nm | | 1546.1 nm | |
| SD λ_{R} (∝ δλ_{R}) | 1.3 nm | | 0.5 nm | |
| Avg. Q-factor | 3567 | 590 | 10067 | 790 |
| Avg. ER | 27.7 dB | 12.8 dB | 25 dB | 21.8 dB |

| | | |
|---|---|---|
| σλ_{R}/FSR | 0.15 | 0.06 |

Thus, the example study demonstrated that the disclosed framework provides for the design and optimization of adiabatic MRRs tolerant to FPVs in silicon photonics. Through an in-depth exploration of critical parameters and performance metrics, the versatility and efficacy of the disclosed framework in addressing the challenges posed by FPVs has been demonstrated. Using this framework, the MRR design analysis process can be streamlined and the generation of optimized adiabatic MRR layouts tailored to meet user-defined constraints is facilitated. Advantageously, by incorporating waveguide and ring parameters in conjunction with FPV effects, the disclosed framework is capable of achieving robust and efficient MRR designs. By systematically analyzing the impact of FPVs on performance metrics such as resonant wavelength, Q-factor, and extinction ratio, the disclosed framework also provides valuable insights into the design considerations useful for ensuring reliable MRR operation post fabrication.

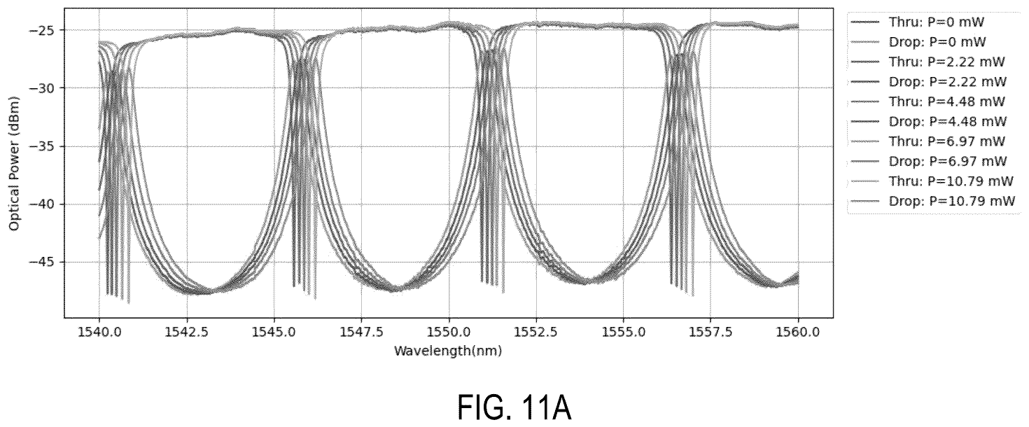

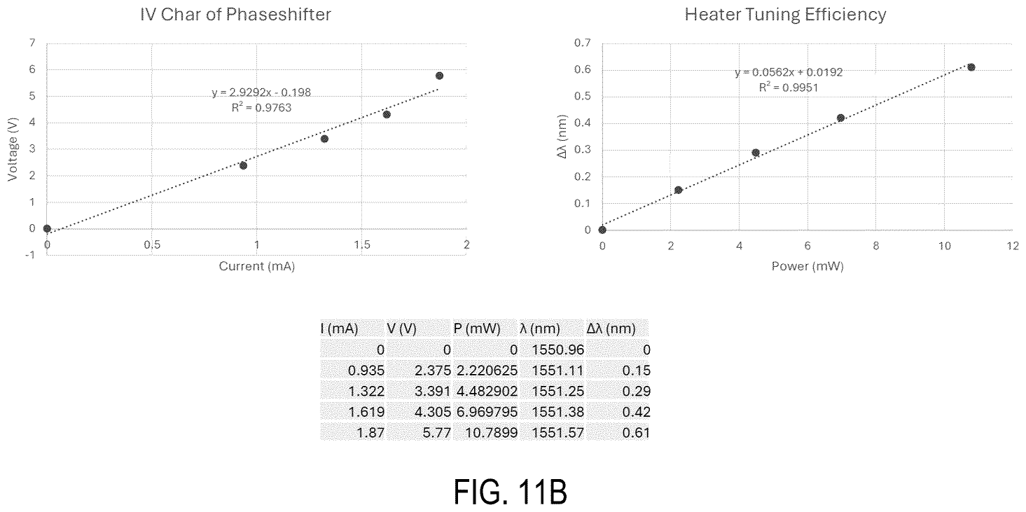

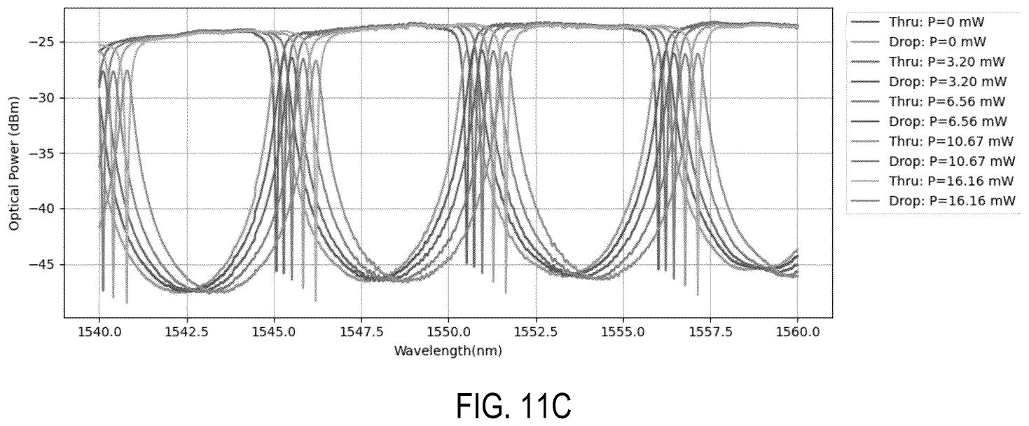

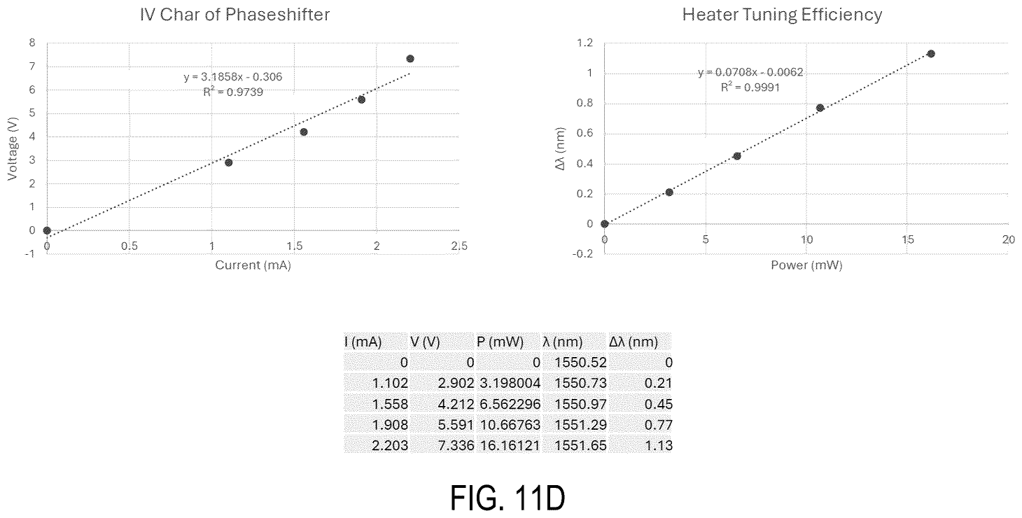

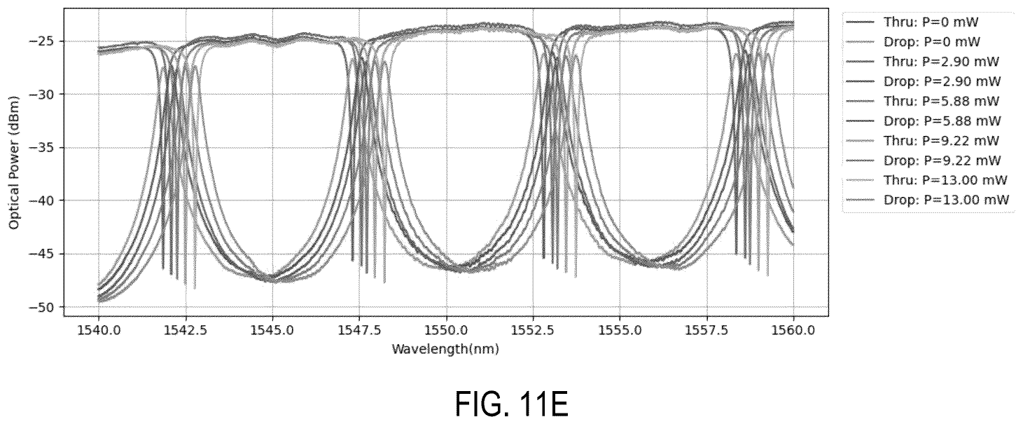

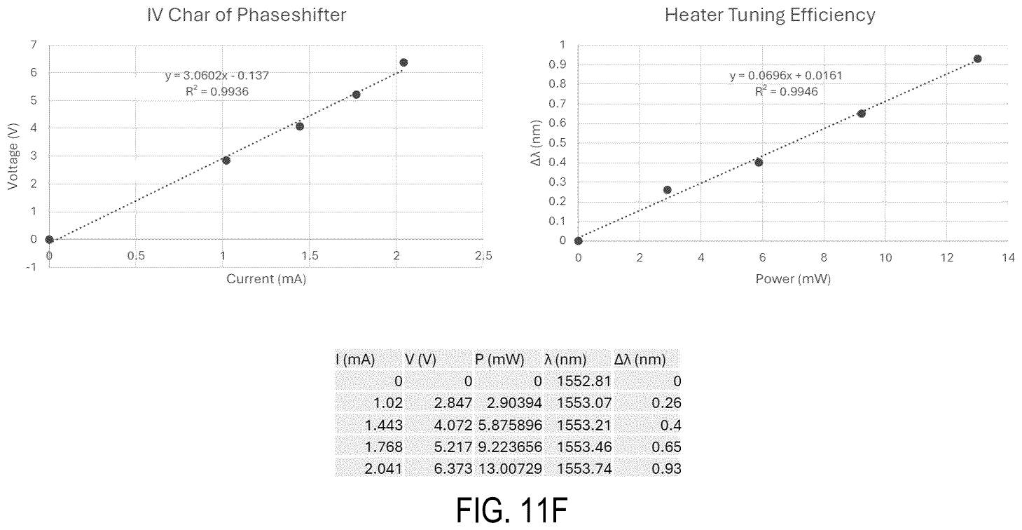

FIG. 9 shows an example of a photonic integrated circuit (PIC) that includes active adiabatic MRRs designed using the methods described in the present disclosure. The PIC is designed to include microring modulators (MRMs) that include microheaters for large-range calibration and PN junctions for optical modulation. In use, current through the microheaters can be varied while taking wavelength sweeps. FIG. 10 shows an example arrangement for MRM heater testing of the PIC shown in FIG. 9. In an example, the MRM devices numbered 4-6 were tested. Results of the MRM sweep data and heater performance data for MRM devices 4-6 are shown in FIGS. 11A-11F.

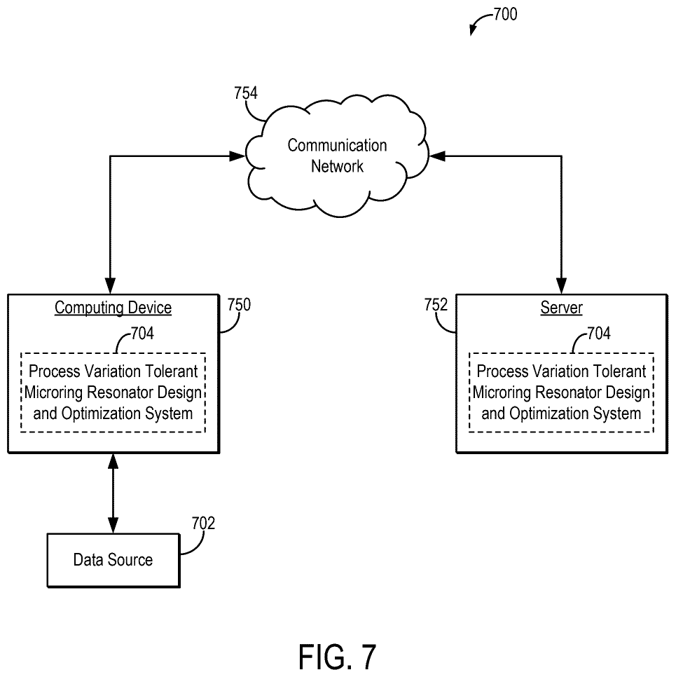

FIG. 7 shows an example of a system 700 for designing process variation tolerant MRRs in accordance with some embodiments described in the present disclosure. As shown in FIG. 7, a computing device 750 can receive one or more types of data (e.g., FPV map data, waveguide parameter data) from data source 702. In some embodiments, computing device 750 can execute at least a portion of a process variation tolerant microring resonator design and optimization system 704 to design and optimize an MRR from data received from the data source 702.

Additionally or alternatively, in some embodiments, the computing device 750 can communicate information about data received from the data source 702 to a server 752 over a communication network 754, which can execute at least a portion of the process variation tolerant microring resonator design and optimization system 704. In such embodiments, the server 752 can return information to the computing device 750 (and/or any other suitable computing device) indicative of an output of the process variation tolerant microring resonator design and optimization system 704.

In some embodiments, computing device 750 and/or server 752 can be any suitable computing device or combination of devices, such as a desktop computer, a laptop computer, a smartphone, a tablet computer, a wearable computer, a server computer, a virtual machine being executed by a physical computing device, and so on.

In some embodiments, data source 702 can be any suitable source of data (e.g., fabrication process variation map data, wafer parameter data, die parameter data, waveguide parameter data, ring parameter data), another computing device (e.g., a server storing fabrication process variation map data, wafer parameter data, die parameter data, waveguide parameter data, ring parameter data), and so on. In some embodiments, data source 702 can be local to computing device 750. For example, data source 702 can be incorporated with computing device 750 (e.g., computing device 750 can be configured as part of a device for measuring, recording, estimating, acquiring, or otherwise collecting or storing data). As another example, data source 702 can be connected to computing device 750 by a cable, a direct wireless link, and so on. Additionally or alternatively, in some embodiments, data source 702 can be located locally and/or remotely from computing device 750, and can communicate data to computing device 750 (and/or server 752) via a communication network (e.g., communication network 754).

In some embodiments, communication network 754 can be any suitable communication network or combination of communication networks. For example, communication network 754 can include a Wi-Fi network (which can include one or more wireless routers, one or more switches, etc.), a peer-to-peer network (e.g., a Bluetooth network), a cellular network (e.g., a 3G network, a 4G network, etc., complying with any suitable standard, such as CDMA, GSM, LTE, LTE Advanced, WiMAX, etc.), other types of wireless network, a wired network, and so on. In some embodiments, communication network 754 can be a local area network, a wide area network, a public network (e.g., the Internet), a private or semi-private network (e.g., a corporate or university intranet), any other suitable type of network, or any suitable combination of networks. Communications links shown in FIG. 7 can each be any suitable communications link or combination of communications links, such as wired links, fiber optic links, Wi-Fi links, Bluetooth links, cellular links, and so on.

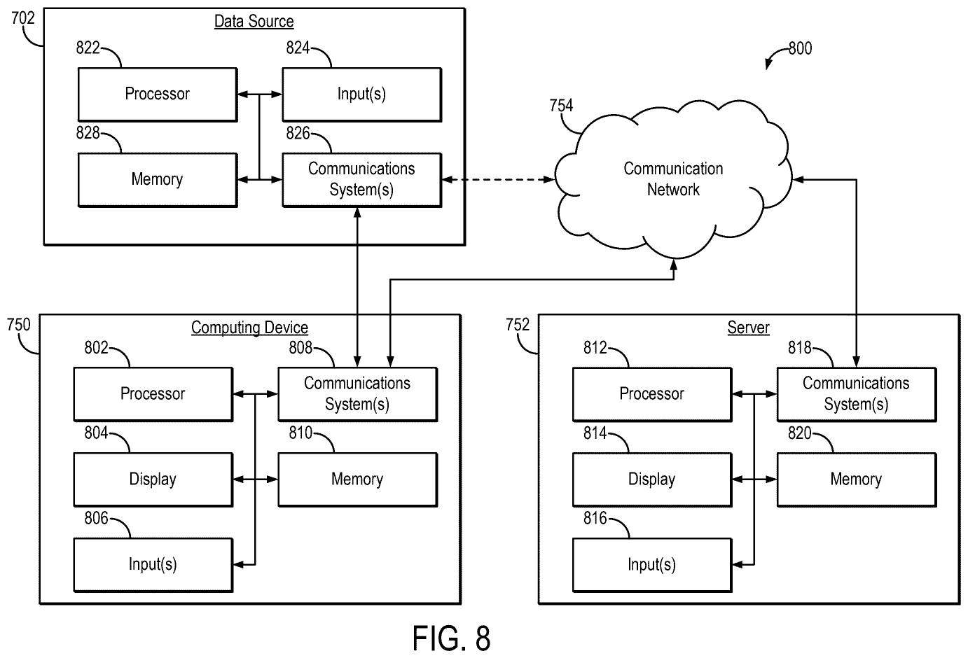

Referring now to FIG. 8, an example of hardware 800 that can be used to implement data source 702, computing device 750, and server 752 in accordance with some embodiments of the systems and methods described in the present disclosure is shown.

As shown in FIG. 8, in some embodiments, computing device 750 can include a processor 802, a display 804, one or more inputs 806, one or more communication systems 808, and/or memory 810. In some embodiments, processor 802 can be any suitable hardware processor or combination of processors, such as a central processing unit (CPU), a graphics processing unit (GPU), and so on. In some embodiments, display 804 can include any suitable display devices, such as a liquid crystal display (LCD) screen, a light-emitting diode (LED) display, an organic LED (OLED) display, an electrophoretic display (e.g., an “e-ink” display), a computer monitor, a touchscreen, a television, and so on. In some embodiments, inputs 806 can include any suitable input devices and/or sensors that can be used to receive user input, such as a keyboard, a mouse, a touchscreen, a microphone, and so on.

In some embodiments, communications systems 808 can include any suitable hardware, firmware, and/or software for communicating information over communication network 754 and/or any other suitable communication networks. For example, communications systems 808 can include one or more transceivers, one or more communication chips and/or chip sets, and so on. In a more particular example, communications systems 808 can include hardware, firmware, and/or software that can be used to establish a Wi-Fi connection, a Bluetooth connection, a cellular connection, an Ethernet connection, and so on.

In some embodiments, memory 810 can include any suitable storage device or devices that can be used to store instructions, values, data, or the like, that can be used, for example, by processor 802 to present content using display 804, to communicate with server 752 via communications system(s) 808, and so on. Memory 810 can include any suitable volatile memory, non-volatile memory, storage, or any suitable combination thereof. For example, memory 810 can include random-access memory (RAM), read-only memory (ROM), electrically programmable ROM (EPROM), electrically erasable ROM (EEPROM), other forms of volatile memory, other forms of non-volatile memory, one or more forms of semi-volatile memory, one or more flash drives, one or more hard disks, one or more solid state drives, one or more optical drives, and so on. In some embodiments, memory 810 can have encoded thereon, or otherwise stored therein, a computer program for controlling operation of computing device 750. In such embodiments, processor 802 can execute at least a portion of the computer program to present content (e.g., images, user interfaces, graphics, tables), receive content from server 752, transmit information to server 752, and so on. For example, the processor 802 and the memory 810 can be configured to perform the methods described herein (e.g., the method of FIGS. 1A-1F, the method of FIG. 4).

In some embodiments, server 752 can include a processor 812, a display 814, one or more inputs 816, one or more communications systems 818, and/or memory 820. In some embodiments, processor 812 can be any suitable hardware processor or combination of processors, such as a CPU, a GPU, and so on. In some embodiments, display 814 can include any suitable display devices, such as an LCD screen, LED display, OLED display, electrophoretic display, a computer monitor, a touchscreen, a television, and so on. In some embodiments, inputs 816 can include any suitable input devices and/or sensors that can be used to receive user input, such as a keyboard, a mouse, a touchscreen, a microphone, and so on.

In some embodiments, communications systems 818 can include any suitable hardware, firmware, and/or software for communicating information over communication network 754 and/or any other suitable communication networks. For example, communications systems 818 can include one or more transceivers, one or more communication chips and/or chip sets, and so on. In a more particular example, communications systems 818 can include hardware, firmware, and/or software that can be used to establish a Wi-Fi connection, a Bluetooth connection, a cellular connection, an Ethernet connection, and so on.

In some embodiments, memory 820 can include any suitable storage device or devices that can be used to store instructions, values, data, or the like, that can be used, for example, by processor 812 to present content using display 814, to communicate with one or more computing devices 750, and so on. Memory 820 can include any suitable volatile memory, non-volatile memory, storage, or any suitable combination thereof. For example, memory 820 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 820 can have encoded thereon a server program for controlling operation of server 752. In such embodiments, processor 812 can execute at least a portion of the server program to transmit information and/or content (e.g., data, images, a user interface) to one or more computing devices 750, receive information and/or content from one or more computing devices 750, receive instructions from one or more devices (e.g., a personal computer, a laptop computer, a tablet computer, a smartphone), and so on.

In some embodiments, the server 752 is configured to perform the methods described in the present disclosure. For example, the processor 812 and memory 820 can be configured to perform the methods described herein (e.g., the method of FIGS. 1A-1F, the method of FIG. 4).

In some embodiments, data source 702 can include a processor 822, one or more inputs 824, one or more communications systems 826, and/or memory 828. In some embodiments, processor 822 can be any suitable hardware processor or combination of processors, such as a CPU, a GPU, and so on. In some embodiments, the one or more inputs 824 are generally configured to receive data, images, or both. Additionally or alternatively, in some embodiments, the one or more inputs 824 can include any suitable hardware, firmware, and/or software for coupling to and/or controlling operations of sensors, measurement devices, and/or other computing devices for receiving data, images, or both. In some embodiments, one or more portions of the input(s) 824 can be removable and/or replaceable.

Note that, although not shown, data source 702 can include any suitable inputs and/or outputs. For example, data source 702 can include input devices and/or sensors that can be used to receive user input, such as a keyboard, a mouse, a touchscreen, a microphone, a trackpad, a trackball, and so on. As another example, data source 702 can include any suitable display devices, such as an LCD screen, an LED display, an OLED display, an electrophoretic display, a computer monitor, a touchscreen, a television, etc., one or more speakers, and so on.

In some embodiments, communications systems 826 can include any suitable hardware, firmware, and/or software for communicating information to computing device 750 (and, in some embodiments, over communication network 754 and/or any other suitable communication networks). For example, communications systems 826 can include one or more transceivers, one or more communication chips and/or chip sets, and so on. In a more particular example, communications systems 826 can include hardware, firmware, and/or software that can be used to establish a wired connection using any suitable port and/or communication standard (e.g., VGA, DVI video, USB, RS-232, etc.), Wi-Fi connection, a Bluetooth connection, a cellular connection, an Ethernet connection, and so on.

In some embodiments, memory 828 can include any suitable storage device or devices that can be used to store instructions, values, data, or the like, that can be used, for example, by processor 822 to control the one or more inputs 824, and/or receive data from the one or more inputs 824; to generate images from data; present content (e.g., data, images, a user interface) using a display; communicate with one or more computing devices 750; and so on. Memory 828 can include any suitable volatile memory, non-volatile memory, storage, or any suitable combination thereof. For example, memory 828 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 828 can have encoded thereon, or otherwise stored therein, a program for controlling operation of data source 702. In such embodiments, processor 822 can execute at least a portion of the program to generate images, transmit information and/or content (e.g., data, images, a user interface) to one or more computing devices 750, receive information and/or content from one or more computing devices 750, receive instructions from one or more devices (e.g., a personal computer, a laptop computer, a tablet computer, a smartphone, etc.), and so on.

By way of example, the system components shown in FIGS. 7 and 8 can work together to implement the method of FIG. 4 for designing process variation tolerant microring resonators. For instance, the data source 702 can provide the initial FPV map data and other input parameters needed to begin the microring resonator design process. This data may be stored in the memory 828 of the data source and transmitted to the computing device 750 via the communication network 754.

The computing device 750 receives this data via the communication network 754. The processor 802 and memory 810 of the computing device 750 then execute the process variation tolerant microring resonator design and optimization system 704 to carry out the steps of the method in FIG. 4. Specifically, the processor 802 accesses the FPV map data (step 402), generates waveguide parameter data based on analysis of the FPV data (step 404), and then generates MRR parameter data through further analysis (step 406). Throughout this process, the computing device 750 may display relevant information to the user via the display 804 and receive user inputs through the inputs 806. This allows for interactive optimization of the MRR design based on user-specified requirements and constraints. In some cases, the computing device 750 may offload some processing to the server 752 via the communication network 754. Additionally or alternatively, the server 752 may execute the process variation tolerant microring resonator design and optimization system 704 to carry out the steps of the method in FIG. 4 in lieu of the computing device 750.

Once the final MRR parameter data is generated, the computing device 750 outputs this data (step 408), such as by displaying it to the user via the display 804 or storing it in memory 810. The MRR parameter data may also be transmitted back to the server 752 or to a fabrication system to direct the actual fabrication of the optimized, process variation tolerant microring resonator (step 410).

In some embodiments, any suitable computer-readable media can be used for storing instructions for performing the functions and/or processes described herein. For example, in some embodiments, computer-readable media can be transitory or non-transitory. For example, non-transitory computer-readable media can include media such as magnetic media (e.g., hard disks, floppy disks), optical media (e.g., compact discs, digital video discs, Blu-ray discs), semiconductor media (e.g., RAM, flash memory, EPROM, EEPROM), any suitable media that is not fleeting or devoid of any semblance of permanence during transmission, and/or any suitable tangible media. As another example, transitory computer-readable media can include signals on networks, in wires, conductors, optical fibers, circuits, or any suitable media that is fleeting and devoid of any semblance of permanence during transmission, and/or any suitable intangible media.

As used herein in the context of computer implementation, unless otherwise specified or limited, the terms “component,” “system,” “module,” “framework,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

The present disclosure has described one or more preferred embodiments, and it should be appreciated that many equivalents, alternatives, variations, and modifications, aside from those expressly stated, are possible and within the scope of the invention.

1. A method for designing a microring resonator, the method comprising:
generating fabrication process variation (FPV) map data with a computer system, wherein the FPV map data comprise at least one FPV map indicating a process variation in a substrate;
generating waveguide parameter data from the FPV map data using the computer system, wherein the waveguide parameter data comprise estimated waveguide parameters as affected by process variations associated with the FPV map data;
generating microring resonator parameter data from the FPV map data and waveguide parameter data using the computer system, wherein the microring resonator parameter data comprise estimated microring resonator parameters as affected by process variations associated with the FPV map data; and
outputting the waveguide parameter data and microring resonator parameter data with the computer system as a design for fabricating a process variation tolerant microring resonator.

2. The method of claim 1, wherein the substrate is a silicon-on-insulator (SOI) wafer.

3. The method of claim 1, wherein the process variation in the substrate comprises at least one of a waveguide width variation or a substrate thickness variation.

4. The method of claim 1, wherein the FPV map data account for radial-variation effects of the substrate.

5. The method of claim 1, wherein the FPV map data account for process variations across a single die of the substrate.

6. The method of claim 1, wherein the FPV map data account for process variations across the substrate.

7. The method of claim 1, wherein the waveguide parameter data comprise changes in at least one of effective index or group index due to changes in waveguide parameters caused by process variations.

8. The method of claim 7, wherein the waveguide parameters comprise at least one of wavelength, waveguide width, or substrate thickness.

9. The method of claim 1, wherein the microring resonator parameter data comprise at least one of changes in resonant wavelength, free spectral range (FSR), or transmission spectrum associated with the process variations.

10. The method of claim 1, wherein microring resonator data comprise at least one of a Q-factor, an extinction ratio, a 3 dB bandwidth, or total resonant wavelength shift associated with the process variations.

11. The method of claim 1, further comprising optimizing the microring resonator design based on user parameters received by the computer system.

12. The method of claim 1, wherein generating the microring resonator parameter data comprises performing a cross-over coupling analysis based on the waveguide parameter data.

13. The method of claim 1, wherein the microring resonator parameter data are generated using a microring resonator analysis comprising a coupler analysis stage, a ring analysis stage, and a ring exploration and optimization stage.

14. The method of claim 12, wherein the coupler analysis stage comprises analyzing cross-over coupling in a microring resonator for given width, radius, and gap parameters in the waveguide parameter data.

15. The method of claim 13, wherein the ring analysis stage comprises:
selecting a ring design to start exploration;
analyzing changes in the ring design based on changes in effective index; and
determining an updated ring design having improved performance towards process variations based on the analyzed changes in the ring design.

16. The method of claim 1, further comprising fabricating a microring resonator based on at least one of the waveguide parameter data or microring resonator parameter data contained in the design for the process variation tolerant microring resonator.

17. The method of claim 16, wherein the microring resonator is an adiabatic microring resonator.

18. The method of claim 1, further comprising generating a layout for the process variation tolerant microring resonator based on the microring resonator parameter data.

19. The method of claim 18, wherein generating the layout comprises creating a layout for fabrication and integration of the process variation tolerant microring resonator into photonic circuits.

20. The method of claim 19, wherein the layout is optimized for tolerance towards fabrication process variations while maintaining a specified performance metric.
